(19) United States
(12) Patent Application Publication
(10) Pub. No.: US 2020/0026116 A1
(43) Pub. Date: Jan. 23, 2020

(54) DISPLAY DEVICE AND DISPLAY APPARATUS

(71) Applicant: Mitsubishi Electric Corporation, Tokyo (JP)

(72) Inventor: Shigeyuki MATSUMOTO, Tokyo (JP)

(73) Assignee: Mitsubishi Electric Corporation, Tokyo (JP)

(21) Appl. No.: 16/441,340

(22) Filed: Jun. 14, 2019

(30) Foreign Application Priority Data
Jul. 18, 2018 (JP) 2018-134973

(51) Int. Cl. G02F 1/1333

(52) U.S. Cl. CPC G02F 1/133308; G02F 2001/133331; G02F 1/13338; G02F 2201/50; G02F 2001/133314

(57) ABSTRACT

In a state of a display device, there is an attached state being a state in which the display device is attached to a housing. In the attached state, a protective plate is configured such that a side surface of the protective plate is held by the housing. The side surface of the protective plate is provided with an elastic body.

### BACKGROUND OF THE INVENTION

### Field of the Invention

The present invention relates to a display device and a display apparatus to be attached to a housing.

### Description of the Background Art

With the spread of information electronic apparatuses in recent years, a display device having a configuration in which a display surface side of the display device is fully flat has been widely spread. In such a display device, a protective plate is provided on the display surface side. The protective plate includes, for example, a transparent plate, a touch panel, and a transparent plate having a touch panel function.

Hereinafter, the display device provided with a protective plate on the display surface side of the display device is also referred to as “display device F”. The forms in which such a display device F is attached to a housing to be used have increased.

Japanese Patent Application Laid-Open No. 2009-122398, Japanese Patent No. 6025423, and Japanese Patent Application Laid-Open Nos. 2012-093667, 2009-216826, and 2015-135430 disclose various configurations of attaching the display device F to a housing. Hereinafter, the configuration disclosed in Japanese Patent Application Laid-Open No. 2009-122398 is also referred to as “related configuration A”. In addition, hereinafter, the configuration disclosed in Japanese Patent No. 6025423 is also referred to as “related configuration B”. In addition, hereinafter, the configuration disclosed in Japanese Patent Application Laid-Open No. 2012-093667 is also referred to as “related configuration C”. In addition, hereinafter, the configuration disclosed in Japanese Patent Application Laid-Open No. 2009-216826 is also referred to as “related configuration D”. In addition, hereinafter, the configuration disclosed in Japanese Patent Application Laid-Open No. 2015-135430 is also referred to as “related configuration E”.

When the display device in which a protective plate is provided on the display surface side of the display device is attached to a housing, there is a form in which the side surface of the protective plate is held by the housing. In such a form, it is required to suppress the occurrence of a gap between the housing and the side surface of the protective plate. The related configurations A, B, C, D, and E cannot meet this requirement.

### SUMMARY

An object of the present invention is to provide a display device and the like capable of suppressing the occurrence of a gap between a housing and a side surface of a protective plate.

A display device according to an aspect of the present invention is a device to be attached to a housing. The display device includes: a display panel having a display surface for displaying an image; a frame configured to hold the display panel; and a protective plate configured to cover a side of the display surface of the display panel. In a state of the display device, there is an attached state being a state in which the display device is attached to the housing. In the attached state, the protective plate is configured such that a side surface of the protective plate is held by the housing. An elastic body is provided on a side surface of the protective plate.

According to the present invention, in the state of the display device, there is an attached state being a state in which the display device is attached to the housing. In the attached state, the protective plate is configured such that a side surface of the protective plate is held by the housing. An elastic body is provided on a side surface of the protective plate.

That is, in the attached state, the side surface provided with an elastic body on a side surface of the protective plate is held by the housing. Thus, the occurrence of a gap between the housing and the side surface of the protective plate can be suppressed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a display apparatus according to a first preferred embodiment;

FIG. 2 is a cross-sectional view of the display apparatus taken along line A1-A2 in FIG. 1;

FIG. 3 is a perspective view of a display device according to the first preferred embodiment;

FIG. 4 is an exploded perspective view of the display device according to the first preferred embodiment;

FIG. 5 is an enlarged view illustrating a cross section of an end portion of a protective plate according to the first preferred embodiment;

FIG. 6 is a diagram for illustrating a configuration of an elastic body in a first modification; and

FIGS. 7 and 8 are cross-sectional views each illustrating a part of a display apparatus as a comparative example.

### DESCRIPTION OF THE PREFERRED EMBODIMENT

Hereinafter, a preferred embodiment will be described with reference to the drawings. In the following drawings, the same components are denoted by the same reference numerals. The names and functions of respective components denoted by the same reference numerals are the same. Therefore, a detailed description of a part of each component denoted by the same reference numeral may be omitted.

It should be noted that the dimensions, materials, and shapes of components exemplified in the preferred embodiment, relative arrangements of such components, and the like may be appropriately changed according to the configuration, various conditions, and the like of the device to which the present invention is applied. In addition, the dimensions of each component in the drawings may differ from the actual dimensions.

### First Preferred Embodiment

(Configuration of Display Apparatus)

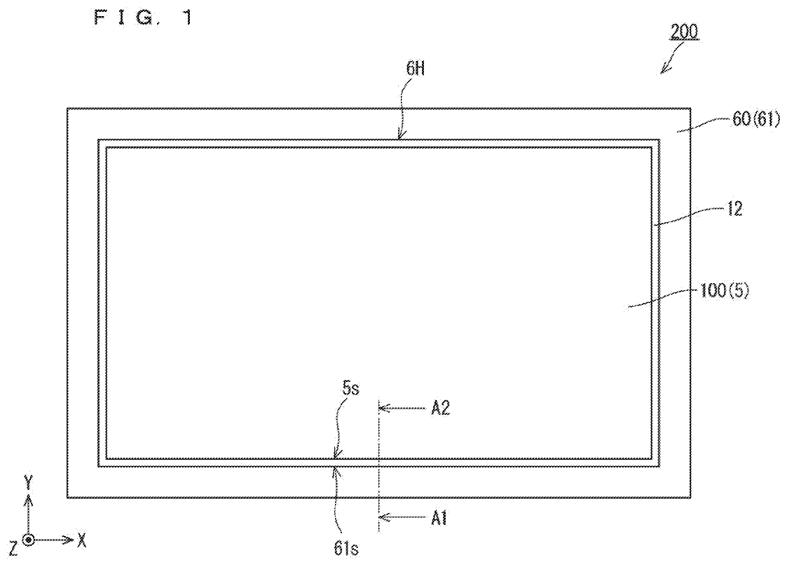

FIG. 1 is a plan view of a display apparatus 200 according to a first preferred embodiment. The display apparatus 200 is an apparatus having a function of displaying an image. In FIG. 1, the X direction, the Y direction, and the Z direction are orthogonal to one another. The X, Y, and Z directions illustrated in the following drawings are also orthogonal to one another. Hereinafter, a direction including the X direction and a direction opposite to the X direction (−X direction) is also referred to as “X-axis direction”. In addition, hereinafter, a direction including the Y direction and a direction opposite to the Y direction (−Y direction) is also referred to as “Y-axis direction”. In addition, hereinafter, a direction including the Z direction and a direction opposite to the Z direction (−Z direction) is also referred to as “Z-axis direction”.

In addition, hereinafter, a plane including the X-axis direction and the Y-axis direction is also referred to as “XY plane”. In addition, hereinafter, a plane including the X-axis direction and the Z-axis direction is also referred to as “XZ plane”. In addition, hereinafter, a plane including the Y-axis direction and the Z-axis direction is also referred to as “YZ plane”.

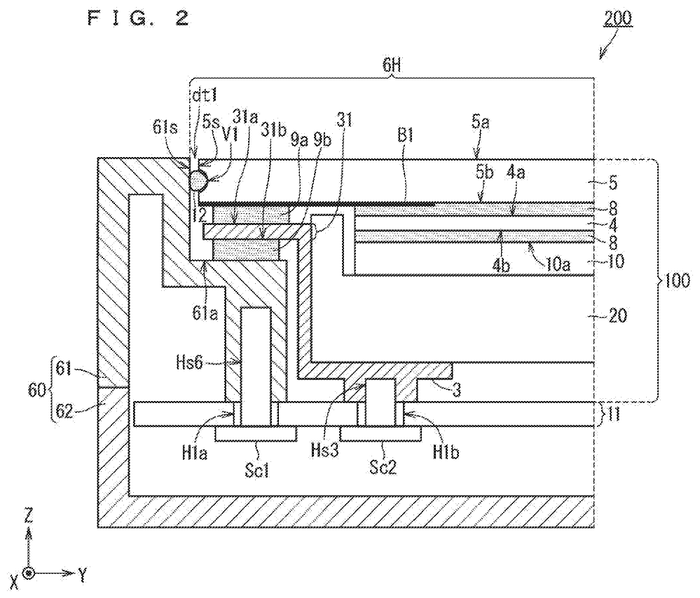

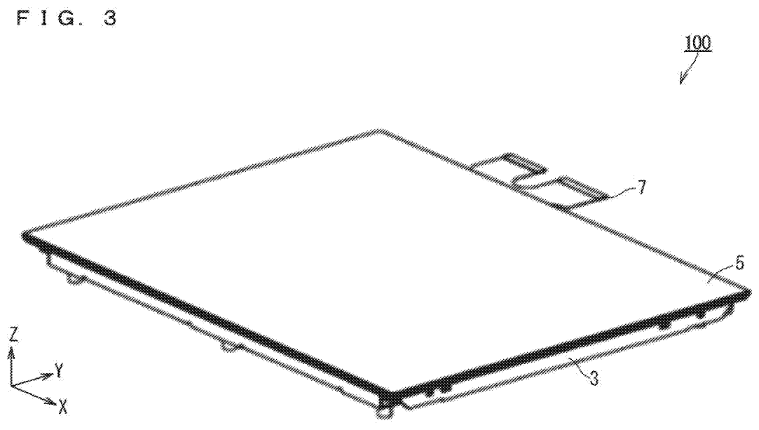

FIG. 2 is a cross-sectional view of the display apparatus 200 taken along line A1-A2 in FIG. 1. Referring to FIGS. 1 and 2, the display apparatus 200 includes a display device 100 and a housing 60. FIG. 3 is a perspective view of the display device 100 according to the first preferred embodiment. The display device 100 is, for example, a liquid crystal display device for displaying an image by using liquid crystal. It should be noted that the display device 100 is not limited to a liquid crystal display device, and may be a display device of another system. The display device 100 may be, for example, an organic electroluminescence (EL) display.

Referring to FIGS. 1, 2, and 3, the display device 100 is a device to be attached to the housing 60. The housing 60 functions as an outer housing of the display device 100.

The housing 60 is configured such that the display device 100 can be attached to and detached from the housing 60. The housing 60 includes an opening 6H. The opening 6H is a space for housing the display device 100. The shape of the opening 6H in a plan view (XY plane) is rectangular. Therefore, the shape of the upper surface of the housing 60 in a plan view (XY plane) is a closed-loop shape (frame shape).

Hereinafter, the state in which the display device 100 is attached to the housing 60 is also referred to as the “attached state”. In the attached state, the display device 100 is housed in the opening 6H of the housing 60. It should be noted that in the attached state, in order for an output wiring member 7 described below to be housed in the opening 6H, the output wiring member 7 is bent.

In addition, hereinafter, the state in which the display device 100 is not attached to the housing 60 is also referred to as “non-attached state”. That is, the state of the display device 100 includes a non-attached state and an attached state. It should be noted that FIG. 2 is a cross-sectional view of the display apparatus 200 (display device 100) in FIG. 1 in the attached state.

Referring to FIG. 2, the housing 60 includes a front surface cover 61 and a rear surface cover 62. In the attached state, the display device 100 is fixed to the housing 60 (front surface cover 61) by a fixing member 11 and screws Sc1, Sc2. In addition, in the attached state, the front surface cover 61 is joined to the rear surface cover 62. The front surface cover 61 has a side surface 61s and a flat surface 61a.

(Configuration of Display Device)

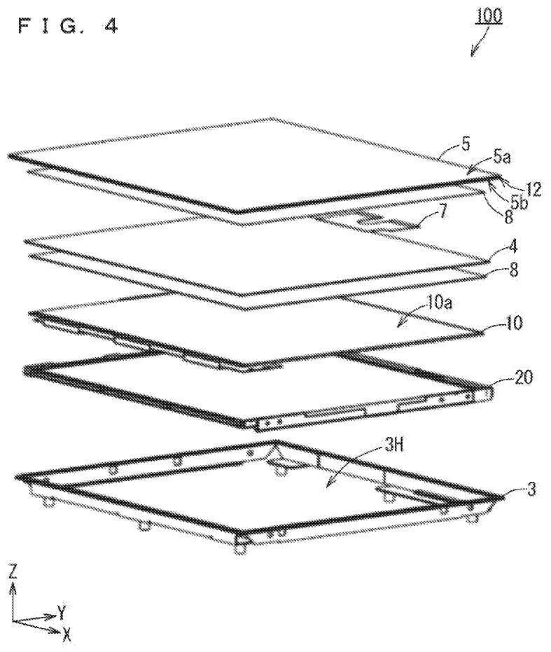

Next, the configuration of the display device 100 will be described. FIG. 4 is an exploded perspective view of the display device 100 according to the first preferred embodiment.

Referring to FIGS. 2, 3, and 4, the display device 100 includes a display panel 10, a light source device 20, a frame 3, a touch panel 4, and a protective plate 5.

The light source device 20 is a device that emits light. The light source device 20 applies light to the back surface of the display panel 10. The frame 3 has an opening 3H. The shape of the frame 3 in a plan view (XY plane) is a closed-loop shape (frame shape). The frame 3 is a flange frame. The frame 3 holds the display panel 10 and the light source device 20.

In addition, the frame 3 includes a flat portion 31 (see FIG. 2). The shape of the flat portion 31 in a plan view (XY plane) is a closed-loop shape (frame shape). The flat portion 31 has a front surface 31a and a back surface 31b. The front surface 31a of the flat portion 31 is provided with a joint member 9a.

The display panel 10 has a function of displaying an image. The display panel 10 has a display surface 10a for displaying an image. A touch panel 4 is provided on the display surface 10a side of the display panel 10. The touch panel 4 is a panel for receiving a touch operation by the user. The touch operation is an operation in which the user touches the touch panel 4. The touch panel 4 has a front surface 4a and a back surface 4b. The back surface 4b is a surface opposite to the front surface 4a of the touch panel 4.

In addition, the protective plate 5 is provided on the front surface 4a side of the touch panel 4. The protective plate 5 is a plate for protecting the touch panel 4. The protective plate 5 is, for example, a transparent plate. The size of the protective plate 5 in a plan view (XY plane) is larger than the size of the display panel 10 in a plan view (XY plane). In addition, the shape of the protective plate 5 in a plan view (XY plane) is rectangular (see FIG. 1). In addition, the shape of the side surface 61s of the front surface cover 61 in a plan view (XY plane) is rectangular (see FIG. 1).

The protective plate 5 has a front surface 5a, a back surface 5b, and a side surface 5s. The back surface 5b is a surface opposite to the front surface 5a of the protective plate 5. The shape of the side surface 5s in a plan view (XY plane) is rectangular (see FIG. 1).

It should be noted that the frame 3 is configured such that the flat portion 31 of the frame 3 faces a rim portion of the back surface 5b of the protective plate 5. The rim portion of the back surface 5b of the protective plate 5 is fixed to the front surface 31a of the flat portion 31 of the frame 3 via the joint member 9a.

The touch panel 4 (front surface 4a) is fixed to the back surface 5b of the protective plate 5 via an adhesive member 8. The adhesive member 8 is, for example, a transparent adhesive material. The display panel 10 is fixed to the back surface 4b of the touch panel 4 via the adhesive member 8.

It should be noted that the display panel 10 and the touch panel 4 are not directly fixed to the frame 3. Specifically, the frame 3 holds the display panel 10 and the touch panel 4 via the protective plate 5.

In addition, the output wiring member 7 is fixed to an end portion of the touch panel 4. The output wiring member 7 is a member for outputting a signal from the touch panel 4. The output wiring member 7 has flexibility.

Next, each of the members constituting the display device 100 will be described in more detail.

(Display Panel)

The display panel 10 is, for example, a transmissive liquid crystal panel. The liquid crystal panel is a panel to which birefringence of the liquid crystal material is applied. The liquid crystal panel includes a color filter substrate, a TFT substrate, a spacer, a sealing member, a liquid crystal layer, an alignment film, and a polarizing plate.

Each of the color filter substrate and the TFT substrate is an insulating substrate made of glass or the like. The color filter substrate is a substrate on which a colored layer (color filter), a light shielding layer, a counter electrode, and the like are formed. In addition, the TFT substrate is a substrate on which pixel electrodes and the like including thin transistors are formed. Hereinafter, the thin transistor is also referred to as a “thin film transistor (TFT)”. The TFT is a switching element provided on the substrate.

The color filter substrate and the TFT substrate are provided to face each other. The spacer is provided to create a predetermined space (gap) between the color filter substrate and the TFT substrate. The sealing member is a member for bonding the color filter substrate and the TFT substrate to each other.

The liquid crystal layer is sandwiched between the color filter substrate and the TFT substrate. The liquid crystal layer is a layer including liquid crystals. It should be noted that in the display panel 10, a sealing material is provided in an injection port for injecting a liquid crystal into the liquid crystal layer. The alignment film is a film for aligning a liquid crystal constituting the liquid crystal layer. The polarizing plate transmits only light vibrating in a specific direction.

It should be noted that the display panel 10 is not limited to a liquid crystal panel, and may be a panel of another system. The display panel 10 may be, for example, a plasma panel using plasma technology.

(Light Source Device)

The light source device 20 includes a light source (not shown), a light guide plate (not shown), and a case (not shown). The case holds the light source and the light guide plate. The light source emits light. The light guide plate emits the light emitted from the light source to the back surface of the display panel 10.

(Touch Panel)

The touch panel 4 includes a transparent substrate and a circuit including a transparent electrode formed on the transparent substrate. The touch panel 4 converts information related to position coordinates input from the outside (user) into an electrical signal with the above circuit. Then, the touch panel 4 transmits the electric signal to an external control circuit (not shown) via the output wiring member 7.

It should be noted that the touch panel 4 in the present preferred embodiment is, as an example, a projected capacitive touch panel. The touch panel 4 detects a position with which a user's fingertip or the like is to come into contact (hereinafter, also referred to as a “contact position”). Then, the touch panel 4 measures the ratio of the contact position and the amount of current due to a plurality of electrode patterns near the contact position. Thus, the touch panel 4 precisely identifies the contact position, and receives an input of a signal corresponding to the contact position.

In addition, the touch panel 4 is made of a transparent material. The transparent material includes glass, plastic, or the like. Specifically, each of the upper and lower portions of the touch panel 4 is provided with a substrate. The substrate is made of transparent glass or the like.

In addition, from the viewpoint of cost and weight reduction of the device, the touch panel 4 is desirably thinner. In the touch panel 4, for example, glass widely used for liquid crystal display panels is used because glass is appropriate for the formation process of the transparent electrode. The thickness of the glass is, for example, 0.7 mm or less. Thus, a highly reliable substrate can be easily obtained as the substrate of the touch panel 4, and the cost can also be suppressed.

(Protective Plate)

The protective plate 5 is a member for preventing damage, deformation, abrasion, dirt, and the like due to pressurization, contact, or the like from outside to the touch panel 4 and the display panel 10. The protective plate 5 is made of a transparent material such as glass or plastic. It should be noted that the rim portion of the back surface 5b of the protective plate 5 is provided with a light shielding member B1 (light shielding print portion).

In the present preferred embodiment, as an example, the protective plate 5 is made of glass having high strength and less likely to be deformed. In addition, the thickness of the protective plate 5 is larger than the thickness of the color filter substrate and the thickness of the TFT substrate of the display panel 10, the thickness of the touch panel 4, and the like. That is, the protective plate 5 has higher rigidity than other members (color filter substrate, TFT substrate, touch panel 4, and the like).

The protective plate 5 covers the display surface 10a side of the display panel 10. Specifically, the protective plate 5 is joined to the touch panel 4 joined to the display surface 10a of the display panel 10.

It should be noted that the display device 100 may have a configuration that does not include the touch panel 4 (hereinafter, also referred to as “modified configuration A”). In the modified configuration A, the protective plate 5 is joined to the display surface 10a of the display panel 10. It should be noted that in the modified configuration A, the protective plate 5 may have a touch panel function. That is, the protective plate 5 may be a touch panel.

In addition, printing, painting operation, or the like may be performed on the front surface 5a or the back surface 5b of the protective plate 5. Thus, a function as a design member can also be added to the protective plate 5. In addition, anti-glare (AG) treatment, anti-reflection (AR) treatment, or the like for the purpose of preventing reflection may be performed on the front surface 5a of the protective plate 5. Thus, the visibility of the image can be improved.

In addition, micro unevenness machining, antifouling treatment, water repellent treatment, oil repellent treatment, and the like may be performed on the front surface 5a of the protective plate 5. Thus, the slipperiness, antifouling property, and the like of a finger, a dedicated pen, or the like when the touch panel 4 is operated can be improved.

(Frame)

The frame 3 is a member for holding (storing) the light source device 20, the display panel 10, and the touch panel 4. The frame 3 is made of a thin plate metal, a resin molded object, or the like. When the frame 3 is made of a thin plate metal, the frame 3 is provided with a cutting for machining (not shown) as necessary. The frame 3 may be integrally formed or may be configured by combining a plurality of members.

It should be noted that in the attached state, the frame 3 is fixed to the fixing member 11 by the screw Sc2 (see FIG. 2). The fixing member 11 is fixed to the front surface cover 61 by a screw 5d. Therefore, in the attached state, the frame 3 is held by the front surface cover 61 (housing 60).

(Adhesive Member)

The adhesive member 8 is made of a transparent adhesive material. The shape of the adhesive member 8 is, for example, a sheet shape. It should be noted that the shape of the adhesive member 8 is not limited to a sheet shape. The adhesive member 8 may be, for example, a member having fluidity. In this case, the adhesive member 8 is a curable resin. The curable resin is a resin that is cured by ultraviolet light (UV), heat, or the like.

As described above, the display panel 10 is fixed to the back surface 4b of the touch panel 4 via the adhesive member 8. In addition, as described above, the touch panel 4 (front surface 4a) is fixed to the back surface 5b of the protective plate 5 via the adhesive member 8. The configuration in which both display panel 10 and touch panel 4 are fixed improves the bending stress and has a form less likely to be deformed, as compared with the configuration in which each member is fixed alone.

It should be noted that in the above modified configuration A in which the display device 100 does not include the touch panel 4, for example, the display panel 10 is fixed to the protective plate 5 via the adhesive member 8.

(Joint Member)

The joint members 9a, 9b are members having adhesiveness. Each shape of the joint members 9a, 9b is a closed-loop shape (frame shape) in a plan view (XY plane). The joint members 9a, 9b are, for example, a foam double-sided adhesive tape or the like. It should be noted that the foam double-sided adhesive tape is configured by providing a double-sided tape, an adhesive, or the like to a buffer member having cushioning properties (resilience). The buffer member is a resin-made member, and made of a curable resin, and the like. The curable resin is a resin in which an adhesive force becomes strong as time passes. Using a curable resin allows adhesiveness to be further improved.

It should be noted that the foam double-sided adhesive tape may be integrally formed or may be configured by combining a plurality of members.

As described above, the rim portion of the back surface 5b of the protective plate 5 is fixed to the flat portion 31 of the frame 3 via the joint member 9a.

(Fixing Member)

The fixing member 11 is a member used to fix the display device 100 to the housing 60 (front surface cover 61). The fixing member 11 is made of metal or resin.

The fixing member 11 is provided with holes H1a, H1b as mounting holes. The holes H1a, H1b are holes into which the screws Sc1, Sc2 are inserted, respectively.

In addition, the fixing member 11 is subjected to thread groove machining.

The holes H1a, H1b are holes used to fix the display device 100 (fixing member 11) to the housing 60 (front surface cover 61) with the screws Sc1, Sc2. It should be noted that the frame 3 is provided with a hole Hs3 being a screw hole. In addition, the front surface cover 61 is provided with a hole Hs6 being a screw hole.

It should be noted that in the attached state, the screw Sc2 protruding from the hole H1b of the fixing member 11 is screwed into the hole Hs3 of the frame 3. In addition, in the attached state, the screw Sc1 protruding from the hole H1a of the fixing member 11 is screwed into the hole Hs6 of the front surface cover 61. That is, the frame 3 of the display device 100 is fixed to the housing 60 (front surface cover 61) via the fixing member 11 by the screws Sc1, Sc2.

Thus, in the attached state, in a state where the display device 100 is pressurized from the protective plate 5, the joint members 9a, 9b, and the back surface 31b side of the flat portion 31 of the frame 3, the display device 100 is fixed to the front surface cover 61 of the housing 60 by the screw Sc1.

In this state, the joint member 9b existing between the flat surface 61a of the front surface cover 61 and the flat portion 31 of the frame 3 is compressed. Thus, the gap between the flat portion 31 of the frame 3 and the flat surface 61a of the front surface cover 61 is closed and hermetically sealed. Therefore, in the attached state, the flat portion 31 of the frame 3 is fixed to the flat surface 61a of the front surface cover 61 via the joint member 9b.

It should be noted that a compressive force or the like is not applied to the joint member 9a existing between the protective plate 5 and the flat portion 31 of the frame 3. The protective plate 5 is bonded and held to the flat portion 31 of the frame 3 only by the adhesive force of the joint member 9a.

(Characteristic Configuration)

Next, the characteristic configuration (hereinafter also referred to as “configuration Ctl”) in the present preferred embodiment will be described in detail. It should be noted that although details will be described below, in the attached state, the protective plate 5 is configured such that the side surface 5s of the protective plate 5 is held by the housing 60 (front surface cover 61) (see FIGS. 1 and 2).

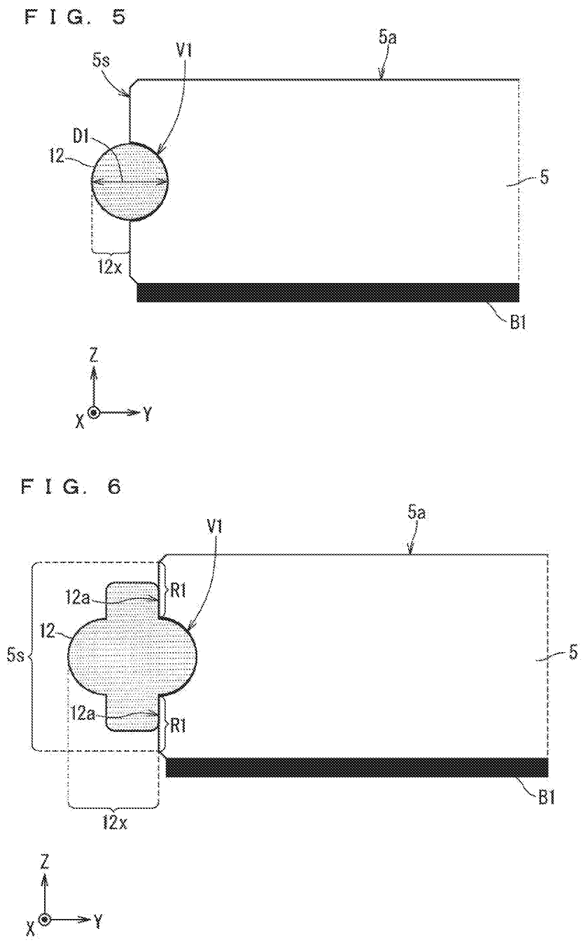

FIG. 5 is an enlarged view illustrating a cross section of an end portion of the protective plate 5 according to the first preferred embodiment. Referring to FIGS. 2, 4, and 5, the display device 100 further includes an elastic body 12. The elastic body 12 has elasticity. The elastic body 12 is made of, for example, rubber. The elastic body 12 is, for example, packing. It should be noted that the elastic body 12 is not limited to the packing, and may be another member having elasticity. The shape of the elastic body 12 in a plan view (XY plane) is a closed-loop shape (frame shape) (see FIG. 1).

In addition, a recess V1 is provided on the side surface 5s of the protective plate 5 corresponding to the entire outline of the protective plate 5 in a plan view (XY plane). The recess V1 is configured such that the recess V1 houses a closed-loop shaped elastic body 12.

The elastic body 12 is fixed to the recess V1. That is, the elastic body 12 is provided on the side surface 5s of the protective plate 5 corresponding to the entire outline of the protective plate 5 in a plan view (XY plane).

In the attached state, the side surface 61s of the housing 60 (front surface cover 61) faces the side surface 5s of the protective plate 5 (see FIG. 2). Hereinafter, the side surface 61s is also referred to as an “opposite surface”.

The shape of the cross section of the elastic body 12 is, for example, a circle. Hereinafter, the diameter of the circle when the cross-sectional shape of the elastic body 12 is a circle is also referred to as “diameter D1”. In addition, hereinafter, the configuration in which the cross-sectional shape of the elastic body 12 is a circle is also referred to as “circle configuration Ctr”. FIG. 5 illustrates the elastic body 12 in the circle configuration Ctr.

The recess V1 is configured such that a part of the cross section of the elastic body 12 protrudes from the recess V1. That is, the recess V1 is configured such that another part of the cross section of the elastic body 12 is housed in the recess V1. The shape of the cross section of the recess V1 is, as an example, an arc shape (semicircular shape). In addition, the recess V1 has elasticity. It should be noted that the recess V1 does not have to have elasticity.

As an example, as illustrated in FIG. 5, the depth of the recess V1 is set such that half of the cross section of the elastic body 12 protrudes from the recess V1 and the other half of the cross section of the elastic body 12 is housed in the recess V1. Hereinafter, the portion protruding from the recess V1 of the elastic body 12 is also referred to as “protruding portion 12x”. In addition, hereinafter, in the attached state, the gap between the side surface 61s of the front surface cover 61 and the side surface 5s of the protective plate 5 is also referred to as a “gap dt1”. The length of the gap dt1 in the horizontal direction is larger than 0 and less than the height of the protruding portion 12x. It should be noted that the ratio of the cross section of the elastic body 12 housed in the recess V1 does not have to be half.

Specifically, in the attached state, the depth of the recess V1 and the protective plate 5 are configured such that the protruding portion 12x comes into contact with the side surface 61s of the front surface cover 61. That is, in the gap dt1 in the attached state, the depth of the recess V1 and the protective plate 5 are configured such that the elastic body 12 elastically deforms. In other words, in the attached state, the protective plate 5 is configured such that the side surface 5s of the protective plate 5 is held by the housing 60 (front surface cover 61).

In addition, in the circle configuration Ctr, in the attached state, the depth of the recess V1 and the protective plate 5 are configured such that a region corresponding to k times the diameter D1 of the cross section of the elastic body 12 elastically deforms, for example. The “k” is a real number. The “k” is, for example, a value in the range of more than 0 and not more than ¼.

It should be noted that the shape of the cross section of the elastic body 12 is not limited to a circle. The shape of the cross section of the elastic body 12 may be, for example, an ellipse.

Hereinafter, the operation of attaching the display device 100 to the housing 60 is also referred to as “attachment operation”. The attachment operation is also an operation of housing the display device 100 into the opening 6H of the housing 60. When the attachment operation is performed, the state of the display device 100 shifts from the non-attached state to the attached state.

Next, the case where the attachment operation is performed will be described. In a period when the state of the display device 100 shifts from the non-attached state to the attached state, the protruding portion 12x (elastic body 12) existing on the side surface 5s of the protective plate 5 comes into contact with the side surface 61s (opposite surface) of the front surface cover 61.

Thus, the protruding portion 12x (elastic body 12) elastically deforms. Therefore, the side surface 61s (opposite surface) applies pressure to the protruding portion 12x (elastic body 12). Therefore, in the attached state, the side surface 5s of the protective plate 5 is held by the housing 60 (front surface cover 61) in a condition where the side surface 61s (opposite surface) applies pressure to the elastic body 12 so that the opening 6H is hermetically sealed. That is, in the attached state, the side surface 5s of the protective plate 5 is held by the housing 60 via the elastic body 12. Therefore, the elastic body 12 (protective plate 5) is in close contact with the side surface 61s (opposite surface) of the front surface cover 61. That is, the protective plate 5 is in close contact with the housing 60 (front surface cover 61) via the protruding portion 12x (elastic body 12).

In addition, as the elastic body 12 elastically deforms, stress is applied to the recess V1, and the recess V1 also slightly elastically deforms. Thus, in the attached state, the adhesion between the protective plate 5 and the housing 60 (front surface cover 61) can be improved.

As described above, according to the present preferred embodiment, an attached state being a state where the display device 100 is attached to the housing 60 exists in the state of the display device 100. In the attached state, the protective plate 5 is configured such that the side surface 5s of the protective plate 5 is held by the housing 60. The side surface 5s of the protective plate 5 is provided with the elastic body 12.

That is, in the attached state, the side surface 5s provided with the elastic body 12 on the side surface 5s of the protective plate 5 is held by the housing 60. Thus, the occurrence of a gap between the housing and the side surface of the protective plate can be suppressed.

In addition, in the present preferred embodiment, in a period when the state of the display device 100 shifts from the non-attached state to the attached state, the protruding portion 12x (elastic body 12) comes into contact with the side surface 61s (opposite surface). Thus, the protruding portion 12x (elastic body 12) elastically deforms. In addition, as the elastic body 12 elastically deforms, the recess V1 also slightly elastically deforms. Therefore, the elastic body 12 (protective plate 5) is in close contact with the side surface 61s (opposite surface).

It should be noted that in the present preferred embodiment, in the gap dt1 in the attached state, the depth of the recess V1 and the protective plate 5 are configured such that the elastic body 12 elastically deforms. Therefore, in the attached state, the elastic body 12 (protective plate 5) is in close contact with the side surface 61s (opposite surface), and the side surface 5s of the protective plate 5 and the elastic body 12 are in close contact.

Thus, the elastic body 12 closes the gap dt1. That is, the opening 6H of the housing 60 is hermetically sealed. Therefore, a waterproof function and a dustproof function can be achieved. In addition, it is possible to prevent water or the like from entering the back surface 5b side of the protective plate 5. Therefore, in the attached state, it is possible to prevent water (liquid), dust, and the like from entering the inside of the opening 6H of the housing 60 in which the display device 100 is housed. That is, in the attached state, it is possible to prevent water, dust, or the like from entering as far as the joint members 9a, 9b and the light shielding member B1 (light shielding print portion).

Thus, it is possible to prevent the joint members 9a, 9b, the light shielding member B1, and the like from being exposed to water, and the joint members 9a, 9b, the light shielding member B1, and the like from being peeled off. Therefore, an effect can be obtained that the housing 60 can hold the display device 100 stably over a long period of time.

In addition, in the present preferred embodiment, the elastic body 12 having elasticity is provided in a closed-loop shape on the side surface 5s of the protective plate 5. Therefore, the effect can be obtained that the assembly operation of attaching the display device 100 including the protective plate 5 to the housing 60 can be easily performed.

In addition, in the present preferred embodiment, it is not necessary to provide a special shape or the like on the front surface cover 61 of the housing 60 as an outer housing. Therefore, the effect can be obtained that the housing 60 can be replaced with a product (housing) already produced and is highly versatile.

Here, a comparative example to be compared with the present preferred embodiment will be described. Hereinafter, a display apparatus in the comparative example is also referred to as “display apparatus 12”. In addition, hereinafter, a display device in the comparative example is also referred to as “display device J1”.

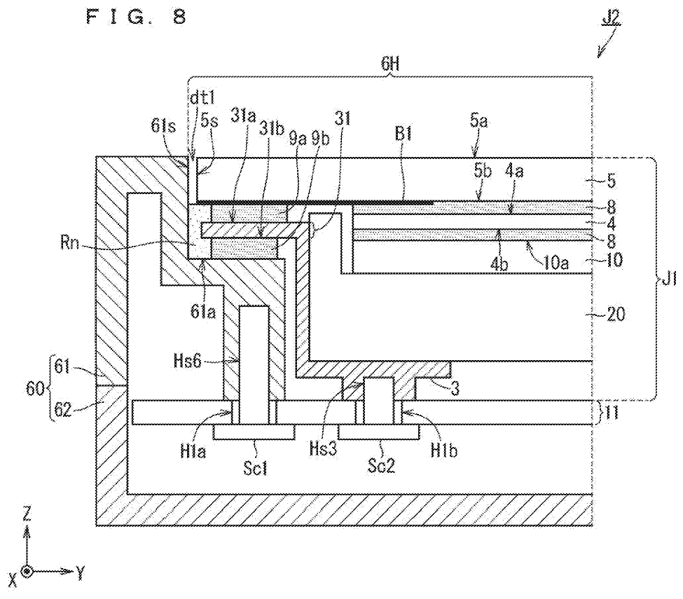

FIG. 7 is a cross-sectional view of a part of a display apparatus J2 as a comparative example. The display apparatus J2 includes a display device J1. The display device J1 differs from the display device 100 in FIG. 2 in that the display device J1 does not include the elastic body 12. The other configuration of the display device J1 is the same as that of the display device 100, so that a detailed description will not be repeated.

In the display apparatus J2 in FIG. 7, in the attached state, a gap dt1 exists between the side surface 61s of the front surface cover 61 and the side surface 5s of the protective plate 5. Therefore, as illustrated in FIG. 8, for example, water may enter the region Rn in the opening 6H1 of the front surface cover 61 via the gap dt1. In this case, there is a problem that the joint members 9a, 9b, the light shielding member B1, and the like may be exposed to water, and the peeling of the joint members 9a, 9b, the light shielding member B1, and the like may occur.

On the other hand, in the display apparatus 200 (display device 100) of the present preferred embodiment, in the attached state, the elastic body 12 closes the gap dt1, and the opening 6H of the housing 60 is hermetically sealed. Therefore, in the present preferred embodiment, the above problem in the display apparatus J2 can be solved.

It should be noted that in recent years, the display devices have been widely spread such that the front surface of the designed housing attached to the display device and the front surface of the protective plate of the display device are seamless.

In such display devices, display devices using the glass bonding technique have increased due to the following purpose A. An example of the purpose A is to prevent the visibility from deterioration due to the front surface reflection of external light.

Another example of the purpose A is to protect the display device from impact, infiltration, dust, and the like from outside. It should be noted that the glass bonding means a method of integrating the display surface of a display device and the protective plate as a transparent member with transparent resin.

In a display device using a glass bonding technique, due to the following purpose B, for example, a configuration using a protective plate having a size larger than the size of the display panel (display surface) of the display device (hereinafter, also referred to as “configuration N”) is used. The purpose B includes a purpose of waterproofing the display device and a purpose of widening the dustproof area. That is, the purpose B is a purpose of achieving a waterproof function, a dustproof function, and the like.

It should be noted that in the related configuration A described above, the display device is held by an outer housing (frame). It should be noted that a transparent protective plate is provided on the front side of the display device. The elastic body is sandwiched between the outer housing and the transparent protective plate so that the elastic body is crushed. The elastic body is, for example, a waterproofed O-ring. Thus, water droplets, dust, and the like from the outside are prevented from entering the inside of the display device.

In addition, in the related configuration B, the side surface of the display device is provided with a recess. The recess is provided with an elastic body. When the display device is attached to a space of a predetermined shape held by the outer housing, elastic deformation of the elastic body fixes the display device to the outer housing.

In addition, in the related configuration C, a step portion is formed in the rim portion of the protective plate. The waterproof tape provided in the step portion bonds the protective plate and the apparatus main body cover. Thus, a waterproof function, a dustproof function, and the like are achieved.

In addition, in the related configuration D, a display window member (protective plate) is provided on the display surface side of the display device. Step portions are formed at two places on the upper side and the lower side of the rim portion of the display window member. A foam double-sided tape is provided at each of the two step portions. In addition, the foam double-sided tape is sandwiched between the display window member and the appearance member (housing) and between the display window member and the back side cover. Thus, the appearance member is bonded to the display window member, and the back side cover is bonded to the display window member. Therefore, the display window member is sandwiched by the appearance member and the back side cover. Thus, a waterproof function, a dustproof function, and the like are achieved.

In addition, in the related configuration E, an annular packing is provided at the edge portion of the cover plate (protective plate). The shape of the cross section of the packing is U-shaped. The cover plate is held by the case via the packing. The front surface of the cover plate abuts on the front surface portion of the packing. The back surface of the cover plate abuts on the back surface portion of the packing. The side surface of the cover plate abuts on the side surface portion of the packing.

It should be noted that in the related configuration C, water, impurities, and the like may enter the gap existing between the protective plate and the apparatus main body cover. In this case, there is a problem that the adhesive force of the waterproof tape is gradually reduced. In addition, when stress is applied to the front surface of the protective plate, peeling force of the waterproof tape occurs. Therefore, when the stress is large, there is a problem that the waterproof tape peels off.

In addition, in the related configuration D, two parts (foam double-sided tape) for holding the display window member (protective plate) are required. In addition, the shape of the display window member is complicated. Therefore, there is a problem that the cost for attaching the display window member to the appearance member and the back side cover is high. In addition, stress tends to be concentrated at the root of the step portion of the display window member. Therefore, there is a problem that the strength of the display window member (protective plate) is low.

Thus, the display device 100 of the present preferred embodiment has a configuration for achieving the above-described effect. Therefore, each of the above problems can be solved by the display device 100 of the present preferred embodiment.

### First Modification

Hereinafter, the configuration of the first preferred embodiment is also referred to as “configuration Ctl”. In addition, the configuration of the present modification is also referred to as “configuration Ctm1”. The configuration Ctm1 is a configuration characterized by the shape of the elastic body 12. The configuration Ctm1 is applied to the configuration Ctl (first preferred embodiment).

It should be noted that in the above circle configuration Ctr, the diameter D1 of the cross section of the elastic body 12 is set based on the dimensional tolerance, the difference of the thermal expansion coefficient, and the like at the time of machining of the protective plate 5, the front surface cover 61, and the like. Therefore, when the size of the protective plate 5 is large, the above-described gap dt1 (that is, opening 6H) needs to be increased. In this case, in the configuration in which the cross-sectional shape of the elastic body 12 is a circle, an ellipse, or the like, there is a problem that it is difficult to close the gap dt1.

In addition, in the configuration in which the thickness of the protective plate 5 is small, the diameter D1 needs to be reduced in accordance with the thickness of the protective plate 5. In the configuration, there is a problem that it is difficult to manufacture the elastic body 12 having the size necessary to close the gap dt1.

Thus, the configuration Ctm1 is a configuration that solves the above problem.

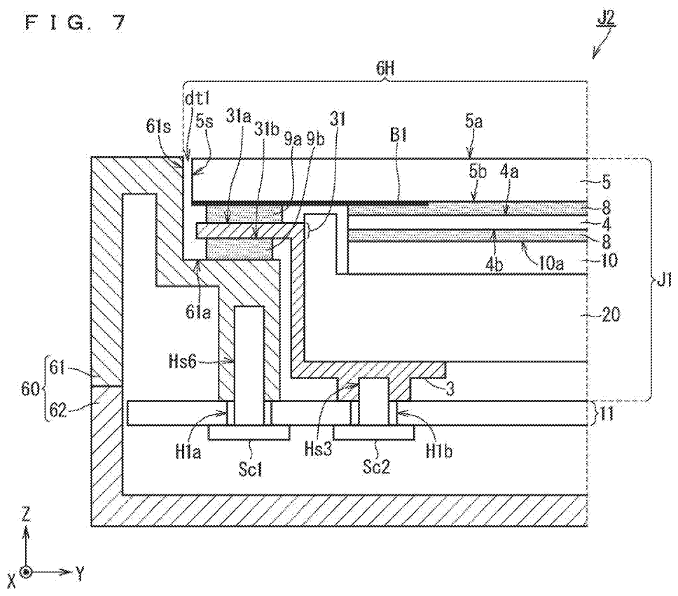

FIG. 6 is a diagram for illustrating the configuration of the elastic body 12 in the first modification.

Referring to FIG. 6, the shape of the cross section of the elastic body 12 in the configuration Ctm1 is a shape other than a circle or an ellipse (hereinafter, also referred to as “deformed shape”). Hereinafter, the region other than the recess V1 in the side surface 5s of the protective plate 5 is also referred to as “flat region R1” or “R1”.

In the configuration Ctm1, the deformed shape being the shape of the cross section of the elastic body 12 is a shape including an ellipse. In addition, in the configuration Ctm1, the elastic body 12 is configured such that the elastic body 12 is in contact with the flat region R1 of the side surface 5s of the protective plate 5. Specifically, the elastic body 12 has a flat surface 12a. The flat surface 12a is a part of the shape of the cross section of the elastic body 12 (deformed shape).

In the attached state, the flat surface 12a is in contact with at least a part of the flat region R1. It should be noted that the flat surface 12a may be configured such that the flat surface 12a is in contact with the entire flat region R1.

As described above, according to the present modification, the elastic body 12 is configured such that the elastic body 12 is in contact with the flat region R1 of the side surface 5s of the protective plate 5. Thus, the setting range of the size of the protective plate 5, the thickness of the protective plate 5, and the like can be expanded. Therefore, the configuration Ctm1 can appropriately correspond to the configuration using the protective plate 5 having various sizes, thicknesses, and the like as compared with the configuration Ctl.

It should be noted that in the present invention, the preferred embodiment and the modification can be freely combined, and the preferred embodiment and the modification can be appropriately modified or omitted within the scope of the present invention. For example, the shape of the display apparatus 200 may be a shape other than that of a rectangle. The shape of the display apparatus 200 has only to be a shape in which the closed-loop shaped (frame shaped) elastic body 12 can be arranged so that the protective plate 5 is in close contact with the housing 60 (opposite surface).

While the invention has been shown and described in detail, the foregoing description is in all aspects illustrative and not restrictive. It is therefore understood that numerous modifications and variations can be devised without departing from the scope of the invention.

What is claimed is:

1. A display device for being attached to a housing, the display device comprising:
a display panel having a display surface for displaying an image;
a frame configured to hold the display panel; and
a protective plate configured to cover a side of the display surface of the display panel,
wherein in a state of the display device, there is an attached state being a state in which the display device is attached to the housing,
wherein in the attached state, the protective plate is configured such that a side surface of the protective plate is held by the housing, and
wherein an elastic body is provided on a side surface of the protective plate.

2. The display device according to claim 1, wherein a shape of the elastic body in a plan view is a closed-loop shape.

3. The display device according to claim 1, wherein a side surface of the protective plate corresponding to an entire outline of the protective plate in a plan view is provided with a recess to which the elastic body is to be fixed.

4. The display device according to claim 1,
wherein in the attached state, the housing has an opposite surface facing a side surface of the protective plate, and
wherein in the attached state, a side surface of the protective plate is held by the housing in a condition where the opposite surface applies pressure to the elastic body.

5. The display device according to claim 1, wherein a shape of a cross section of the elastic body is a circle.

6. The display device according to claim 1, wherein a shape of a cross section of the elastic body is a shape including an ellipse.

7. The display device according to claim 6,
wherein a side surface of the protective plate is provided with a recess to which the elastic body is to be fixed, and
wherein the elastic body is configured such that the elastic body is in contact with a region other than the recess of the side surface.

8. A display apparatus comprising:
the display device according to claim 1; and
the housing,
wherein in the attached state, a side surface of the protective plate included in the display device is held by the housing.
